(19) United States
(12) Patent Application Publication
(10) Pub. No.: US 2025/0207625 A1
(43) Pub. Date: Jun. 26, 2025

(54) COUPLING SYSTEM, WASHER AND METHOD OF COUPLING

(71) Applicant: Rippleaffect Trust Limited, Motueka (NZ)

(72) Inventor: John Dennis WOODMAN, Motueka (NZ)

(21) Appl. No.: 18/989,852

(22) Filed: Dec. 20, 2024

(30) Foreign Application Priority Data
Dec. 21, 2023 (NZ) 806912
Mar. 21, 2024 (NZ) 809375
Sep. 18, 2024 (NZ) 814644

(51) Int. Cl. F16B 43/02; E04B 1/38

(52) U.S. Cl. CPC F16B 43/02; E04B 1/388

(57) ABSTRACT

Described herein is a coupling system, washer and method of coupling. The coupling system described couples vertical structures such as wall framing to a horizontal structure such as a building foundation. The coupling system may couple in a manner that is structural and which avoids a weakened area immediately beneath the vertical structure such as an insulated outer edge of a foundation platform.

### RELATED APPLICATIONS

This application derives priority from New Zealand patent application number 806912 filed on 21 Dec. 2023 with WIPO DAS code A231; and New Zealand patent application number 809375 filed on 21 Mar. 2024 with WIPO DAS code A276; and New Zealand patent application number 814644 filed on 18 Sep. 2024 with WIPO DAS code D2F9; all incorporated herein by reference.

### TECHNICAL FIELD

Described herein is a coupling system, washer and method of coupling. More specifically, a coupling system is described that couple a vertical structure to a horizontal structure and which does so in a manner that is structural and which may be used to avoid a weakened area immediately beneath the vertical structure.

### BACKGROUND ART

Currently vertical structures are coupled to a horizontal structure like a foundation using fasteners such as bolts or screws. These fasteners couple the vertical structures by linking a base of the vertical structure to the horizontal structure via the bolt extending about a vertical plane through the vertical structure and into a part of the horizontal structure e.g. through a base of the vertical framing and into a concrete foundation. Specific bolt types used include epoxy threaded rods, Dynabolts™ and concrete screws.

Whilst these coupling techniques have proved useful, the bolts or screws used require outwardly extending members, e.g. a thread or splayed legs, to achieve a strong coupling. The coupling is also strongest in a purely tension or vertical plane direction but less resilient when subjected to a horizontal loading.

A more recent complication is that of changing standards in concrete foundation design. New codes may require foundation insulation to the outside or close to outside edge of the foundation slab. This complicates the coupling since, using existing techniques for coupling, would mean driving the bolt or screw into the insulating material on the foundation edge which is not of any benefit structurally. Prior to this change in standard, the foundation edge would have comprised a deep concrete layer that was simple to couple to. A thin or no concrete layer where insulation extends to the foundation edge means that the traditional bolt or screw coupling method no longer achieves the desired level of coupling strength.

It may be useful to provide an alternative coupling system to allow vertical structures to be coupled to a horizontal structure in a manner that is strong, controlled and ideally which also address new building codes requiring insulated foundation sides, or at least which provides the public with a choice.

Further aspects and advantages of the coupling system, washer and method of coupling will become apparent from the ensuing description that is given by way of example only.

### SUMMARY

Described herein is a coupling system, washer and method of coupling. The coupling system described couples vertical structures such as wall framing to a horizontal structure such as a building foundation. The coupling system may couple in a manner that is structural and which avoids a weakened area immediately beneath the vertical structure such as an insulated outer edge of a foundation platform.

In a first aspect, there is provided a coupling system configured to couple a vertical structure to a horizontal structure comprising:
a fastener;
a washer; and
wherein the washer is configured to direct the fastener on an angle relative to a vertical plane so as to direct, and retain, the fastener once fitted, on an incline angle relative to the vertical plane of the vertical structure and, on an incline angle relative to a horizontal plane of the horizontal structure.

In a second aspect, there is provided a coupling system configured to couple a vertical structure to a horizontal structure comprising:
a fastener;
a washer with a bore therein configured to accept and direct the fastener therethrough; and
wherein the washer bore directs the fastener on an angle relative to a vertical plane so that, when the fastener is inserted into the bore, vertical structure, and horizontal structure to couple the vertical structure and the horizontal structure, the bore directs the fastener on an incline angle relative to the vertical plane of the vertical structure and, on an incline angle relative to a horizontal plane of the horizontal structure.

In a third aspect, there is provided a washer configured to direct and retain a fastener in an angled orientation during coupling of a vertical structure to a horizontal structure, the washer comprising:
a substantially triangular cross-section shape with at least one bearing face that bears on the horizontal structure or the vertical structure and an opposing outer face;
a bore extending from the opposing outer face to the at least one bearing face, the bore configured to accept and direct the fastener therethrough; and
wherein the bore is configured during coupling of a vertical structure to a horizontal structure, to direct the fastener on an incline angle relative to a vertical plane of the vertical structure and, on an incline angle relative to a horizontal plane of the horizontal structure.

In a fourth aspect, there is provided a method of coupling a vertical structure to a horizontal structure by:
selecting a coupling system substantially as described above;
driving the fastener through the washer, the vertical structure and the horizontal structure.

As may be appreciated from the above description, the coupling system described may allow a vertical structure to be coupled to a horizontal structure in a manner that is strong, controlled and ideally which also addresses new building codes requiring insulated foundation sides i.e. with coupling in a direction away from an insulated side.

### BRIEF DESCRIPTION OF THE DRAWINGS

Further aspects of the coupling system, washer and method of coupling will become apparent from the following description that is given by way of example only and with reference to the accompanying drawings in which:

FIG. 1 shows a schematic cross-section front elevation view of a coupling assembly coupling a vertical structure and horizontal structure;

FIG. 2 shows a side view of one example of a washer used in the coupling assembly;

FIG. 3 shows a perspective view from above of an alternative example of a washer used in the coupling assembly;

FIG. 4 shows a cross-section front elevation view of a further alternative example of a washer used in the coupling assembly coupled to the base of a vertical structure;

FIG. 5 shows a perspective view from above of a further alternative example of a washer used in the coupling assembly;

FIG. 6 shows a side elevation view of the washer of FIG. 5;

FIG. 7 shows an underside elevation view of the washer of FIG. 5;

FIG. 8 shows a perspective view from above of a prior art bracket widely used in construction marketed as the HANDIBRAC™ described further in New Zealand registered design no. 420161;

FIG. 9 shows a perspective view from above of an alternative washer embodiment fitted to the bracket of FIG. 8 with a fastener loosely fitted in to washer bore ready for assembly;

FIG. 10 shows a perspective drawing of the above alternative washer alone;

FIG. 11 shows a plan elevation view of the above alternative washer alone;

FIG. 12 shows a front elevation view of the above alternative washer alone;

FIG. 13 shows a side elevation view of the above alternative washer alone;

FIG. 14 shows a schematic of the washer (with and without brackets) used to couple a vertical structure to a horizontal structure;

FIG. 15 shows a photograph of a series of bolts and washers fixed to a concrete foundation in preparation for pull out testing;

FIG. 16 shows an example of a bolt post testing with the washer removed;

FIG. 17 shows a graph comparing the pull out strength against measured deflection for an M12 diameter bolt inclined at 15, 20 and 25 degrees relative to a vertical plane;

FIG. 18 shows a graph comparing the pull out strength against measured deflection for an M16 diameter bolt inclined at 15, 20, 25 and 30 degrees relative to a vertical plane;

FIG. 19 shows a perspective view from above of an example of an alternative shape washer; and

FIG. 20 shows a perspective view from above of a further example of an alternative shape washer.

### DETAILED DESCRIPTION

As noted above, described herein is a coupling system, washer and method of coupling. The coupling system described couples vertical structures such as wall framing to a horizontal structure such as a building foundation. The coupling system may couple in a manner that is structural and which avoids a weakened area immediately beneath the vertical structure such as an insulated outer edge of a foundation platform.

For the purposes of this specification, the term ‘about’ or ‘approximately’ or ‘substantially’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘comprise’ and grammatical variations thereof shall have an inclusive meaning—i.e. that it will be taken to mean an inclusion of not only the listed components it directly references, but also other non-specified components or elements.

### Coupling System

In a first aspect, there is provided a coupling system configured to couple a vertical structure to a horizontal structure comprising:
a fastener;
a washer; and
wherein the washer is configured to direct the fastener on an angle relative to a vertical plane so as to direct, and retain, the fastener once fitted, on an incline angle relative to the vertical plane of the vertical structure and, on an incline angle relative to a horizontal plane of the horizontal structure.

In a second aspect, there is provided a coupling system configured to couple a vertical structure to a horizontal structure comprising:
a fastener;
a washer with a bore therein configured to accept and direct the fastener therethrough; and
wherein the washer bore directs the fastener on an angle relative to a vertical plane so that, when the fastener is inserted into the bore, vertical structure, and horizontal structure to couple the vertical structure and the horizontal structure, the bore directs the fastener on an incline angle relative to the vertical plane of the vertical structure and, on an incline angle relative to a horizontal plane of the horizontal structure.

### Washer

In a third aspect, there is provided a washer configured to direct and retain a fastener in an angled orientation during coupling of a vertical structure to a horizontal structure, the washer comprising:
a substantially triangular cross-section shape with at least one bearing face that bears on the horizontal structure or the vertical structure and an opposing outer face;
a bore extending from the opposing outer face to the at least one bearing face, the bore configured to accept and direct the fastener therethrough; and
wherein the bore is configured during coupling of a vertical structure to a horizontal structure, to direct the fastener on an incline angle relative to a vertical plane of the vertical structure and, on an incline angle relative to a horizontal plane of the horizontal structure.

### Method of Coupling

In a fourth aspect, there is provided a method of coupling a vertical structure to a horizontal structure by:
selecting a coupling system substantially as described above;
driving the fastener through the washer, the vertical structure and the horizontal structure.

### Coupling

The term ‘coupling’ and grammatical variations thereof refers to the function of retaining together separate items. Retention may be permanent where the parts must be deformed or broken to detach. Alternatively, retention may be releasable.

### Vertical Structure

Vertical structure or vertical structures may refer to building elements such as wall framing, wall panels and similar structures. Timber or steel framing are common materials and structures used in residential construction. These are typically prefabricated off site and then installed on site onto a preformed foundation (the horizontal structure). Panels such as structurally insulated panels (SIP) may also fall within the definition of a vertical structure. Vertical structures as the term is used herein may also encompass poles, posts, beams, portal frames and so on and need not be partly or fully prefabricated structures like framing. Materials common in such as structures may be wood and steel and both of these materials may be coupled by the described coupling system.

The term ‘vertical’ is used to refer to structures that when installed are in a vertical or near vertical plane. These vertical structures need not be entirely vertical about their full height. For example, the coupling system may be used about a vertical footing of the vertical structure and the vertical structure may then curve or step away from a vertical plane as the vertical structure extends away from the footing.

### Horizontal Structure

Horizontal structure or horizontal structures may refer to building elements such as concrete or timber foundations or piles and similar structures. Concrete or concrete and insulating materials composite foundations are common in building structures as are wood, concrete or steel piles.

These are typically created in situ at a building site in advance of vertical structure addition.

As noted earlier in this specification, a complication of more recent building code changes may be that of coupling vertical and horizontal structures together where the horizontal structure may have a low strength material such as insulation about the coupling point or points. The low strength material may compromise coupling strength and eventual building resilience.

The term ‘horizontal’ is used to refer to structures that, when formed, are in a horizontal or near horizontal plane usually defining a flat planar surface or surfaces in the case of multiple piles. These horizontal structures need not be entirely horizontal about their full width. For example, the coupling system may be used about a one point of the horizontal structure and the horizontal structure may then curve or step away from the coupling point horizontal plane as the horizontal structure extends away from the coupling point.

### Fastener

The fastener described may be a dynabolt or concrete screw or a threaded rod. The shaft of the fastener may be threaded.

The fastener may be defined by a head, a point, a shaft linking the head and point and members extending from and along part or all of the shaft, the member typically extending orthogonally from the fastener longitudinal axis. The point may extend through the vertical structure and into the horizontal structure on coupling. The fastener head may act as a stop to prevent excess movement of the fastener shaft into the vertical or horizontal structure. The head may remain flush with a top face of the vertical structure or intermediate washer described further below).

The fastener may have a length sufficient to allow for structural applications. The fastener length may be sufficient to extend through the vertical structure and at least 20, or 30, or 40, or 50 mm or more into the horizontal structure.

The fastener may have a toughness, hardness, malleability or other material characteristic sufficient to be driven at an angle and for the fastener shaft and other parts that couple to the horizontal structure to have sufficient characteristics to grip the angled opening formed by the fastener. As may be appreciated, the fastener described that is inserted on an angle relative to the horizontal structure and the vertical structure may have different material characteristic to a fastener coupled in a vertical plane. In a vertical plane fastener, it is the members extending orthogonally from and along part or all of the shaft longitudinal axis that provide the anchoring and structural coupling. These members essentially bite into the surrounding materials and resist a tension force. The fasteners described herein are inserted on an angle relative to both, a horizontal and a vertical plane, the result being that lines of force imposed on the fastener will be different to a vertically aligned fastener. For example, if a purely vertical tension force were applied to the angled fastener described, this tension force would cause not only the orthogonally extending members to bite into the surrounding material but also the shaft of the fastener would also bear on the surrounding material as well. A horizontal force would similarly result in different forces being imposed on the angled fastener described to that of a traditional vertical plane fastener. The fastener described herein may therefore be varied in physical properties to suit the application and angle at which the fastener is driven to couple the vertical and horizontal structures.

The fastener may have a diameter commensurate with the strength desired. For example, the fastener shaft diameter may be greater than 5, or 6, or 7, or 8, or 9, or 10 mm. The fastener shaft diameter may be less than 20, or 19, or 18 mm. The fastener shaft diameter may be from 5 to 20 mm. The fastener may be an M12 or M16 size fastener.

### Washer

As noted, the washer is configured to direct the fastener on an angle relative to a vertical plane so as to direct, and retain the fastener once fitted, on an incline angle relative to the vertical plane of the vertical structures and, on an incline angle relative to the horizontal plane of the horizontal structure.

The incline angle of an installed fastener through the washer may be less than 30 degrees relative to a vertical plane (or conversely, greater than 60 degrees relative to a horizontal plane). The incline angle of an installed fastener through the washer may be less than 30, or 25, or 20 degrees relative to a vertical plane. In the inventors' experience there may be an optimum pull out strength reached at an incline angle of approximately 10 to 30, or 15 to 25, or 16 to 24, or 17 to 23, or 18 to 22, or 19 to 21 degrees. The incline angle of the fastener noted may be a result of the incline angle of the bore in the washer as described further below i.e. the bore has the noted incline angle and the fastener angle fits into and mirrors the bore incline angle.

This angle as noted elsewhere is important to the success of the coupling noted herein. This allows the point of the fastener to couple to a structural substrate e.g. concrete and not a non-structural substrate such as polystyrene insulation. Steeper angles like those described may be sufficient to meet wind and seismic standards for buildings. In trials completed by the inventor using the described coupling system, the coupling system was able to anchor the structure sufficiently well to achieved at least 80 and up to 158 bracing units of strength. Ideal bracing unit systems would achieve 93 bracing units in high wind zones. Ideal seismic standard coupling systems would achieve 109 bracing units in high seismic risk zones. The described coupling system can therefore be designed to meet and vastly exceed ideal wind and seismic standards in terms of bracing units.

In one example, the washer may comprise a substantially triangular cross-section as viewed from a side. In this example, the washer may have a bearing face or faces that bear on a surface of a vertical structure and an opposing outer face. The outer face may point directly away or generally away from the vertical structure.

The substantially triangular shape may be a right angle triangle shape. This shape is likely to be used about a horizontal to vertical transition e.g. at a junction between a vertical structure bottom beam and an upwardly extending post.

The substantially triangular shape may be of other triangular forms and mounted along various points of a vertical structure bottom beam e.g. isosceles triangle, equilateral triangle and so on. A longer side of the triangle (if the side length varies) may bear on the vertical structure.

The substantially triangular shape may have a bore and this bore receives the fastener therethrough. The bore may be located on the triangular cross-section about a generally thicker or wider point of the washer. The bore may have an opening width that: may interfere with the fastener width or, may be smaller than the fastener width, or which is equal to the fastener width, or which is slightly larger than the fastener width. The exact bore size may be commensurate with the fastener. An aim of a close bore to fastener width may be to retain an angle of the fastener during coupling. The bore may prescribe the angle at which the fastener is driven into and retained in the vertical and horizontal structures.

The washer may be manufactured from materials with low or no resilience. That is the washer does not elastically or plastically deform relative to the fastener. It may be important to retain the prescribed angle of fitment for the fastener and hence the washer may be manufactured from a material of a greater hardness and/or resilience to the fastener to ensure the fastener when coupled follows the prescribed bore angle of the washer. Examples of materials that may be used include steels, metals and alloys generally, plastics of sufficient strength, reinforced plastics, ceramics, composites and so on.

The at least one bearing face of the washer may comprise a shape confirming to the shape of a bracket on which the washer is placed.

### Friction Increasing Face

The washer may further comprise at least one friction increasing face. The at least one friction increasing face may bear on the vertical structure to which the washer is placed or abuts. While the fastener is coupled, or prior to fastener coupling, the washer at least one friction increasing face may grip or at least partially fix to the abutting surface to which it is placed. The at least one friction increasing face may comprise spikes or outwardly extending members that may bear on and partially bite into the surface to which the washer is applied e.g. partially bite into the wood of a base frame or a wooden vertical timber structure or a roughened surface that bears on a steel frame section. The use of at least one friction increasing face on the washer may be useful to lock the washer position and avoid any slippage of washer and hence bore or fastener position during coupling.

### Alignment Feature and Bracket Adaptations

The washer may comprise at least one alignment feature configured to align the washer to a bracket or other part intermediate the washer bearing face and the vertical structure.

In New Zealand at least, it is common to use metal brackets about a building frame that are used to help fasten the vertical structure to the horizontal structure. One example of bracket is the bracket shown in New Zealand design registration no. 420161 and marketed under the trade mark HANDIBRAC™. This bracket has a right angle shape and, when fitted to a vertical structure fixes to a vertically orientated face (e.g. vertically aligned framing) and to a horizontally orientated face (e.g. horizontally aligned framing) of the vertical structure. The horizontally aligned region of the bracket is adapted to receive an fastener through an opening that couples the bracket and vertical structure to a horizontal structure below. As noted elsewhere, direct vertical alignment coupling via a fastener is not ideal particularly if the horizontal structure below lacks strength.

The inventor has found that the washer described herein may be used in conjunction with brackets such as the HANDIBRAC™ to direct a fastener on an angle through the washer and bracket opening and into the vertical and horizontal structures. The angle direction urged by the washer may be in a direction that forces the fastener to engage structural parts or more structural parts of the vertical structure and horizontal structure than would be the case for a direct vertically aligned fastener.

The washer in this example may be adapted as noted to comprise at least one alignment feature configured to align the washer to a bracket or other part intermediate the washer bearing face and the vertical structure. The at least one alignment feature may for example comprise channels or other cut out features in to the bearing face of the washer that complement opposing features such as ribs of the bracket. A further alignment feature that may be used comprises a lip or lips about the sides or ends of the washer bearing face. These lips may extend partly below the wider planar face of the bearing face so as to stand somewhat proud of the planar face of the bearing face. These lips may be located or the washer sized so that the lips engage a side or sides or end of a bracket. Engagement may be by one edge or face of the lip or lips bearing on or abutting the bracket edge or end.

As may be appreciated from the examples above, the at least one alignment feature may act to interfere with movement of the washer relative to the bracket. Interference may prevent rotational movement of the washer relative to the bracket in a co-planar manner (typically about a horizontal plane).

### Non-Angled Flat Face

The washer outer face may comprise the bore described above through which the fastener is inserted. The outer face may also comprise a feature such as a non-angled flat face. This feature may be configured to be hit by a hammer or other tool. This may be done to fit the washer to a bearing surface prior to coupling using the fastener. A feature like this may be useful for example where the washer comprises a friction increasing face such as spikes and the washer may be hammered via the feature to tap the spikes into the vertical structure prior to coupling with the fastener.

### Multiple Coupling Systems and Fasteners

Whilst the description above refers only to one coupling system, it should be appreciated that multiple coupling systems may be used to couple a vertical structure to a horizontal structure and reference to one coupling system should not be seen as limiting.

Further, one fastener per washer is described for the coupling system. It is possible that two or more fasteners may be used per washer and/or multiple bores included in the washer. The multiple bores may be of the same or varying angles depending on the design and coupling intended.

### Advantages

As may be appreciated from the above description the coupling system described may allow vertical structures to be coupled to a horizontal structure in a manner that is strong, controlled and ideally which also address new building codes requiring insulated foundation sides i.e. with coupling in a direction away from an insulated side.

The embodiments described above may also be said broadly to consist in the parts, elements and features referred to or indicated in the specification of the application, individually or collectively, and any or all combinations of any two or more said parts, elements or features.

Further, where specific integers are mentioned herein which have known equivalents in the art to which the embodiments relate, such known equivalents are deemed to be incorporated herein as if individually set forth.

### WORKING EXAMPLES

The above described coupling system, washer and method of coupling are now described by reference to specific examples and the following items on item numbers:
1 Coupling system
2 Vertical structure
2a Vertically orientated building framing in the vertical structure
2b Horizontally orientated building framing in the vertical structure
3 Horizontal structure
3a Polystyrene edging insulation in a horizontal structure
3b Concrete floor foundation in a horizontal structure
4 Fastener
5 Washer
6 Bore
7 Insulating area
8 Head
9 Point
10 Shaft
11 Triangular cross-section
12 Bearing face
13 Outer face
14 Friction increasing face
15 Spikes
16 Non-angled flat face
17 Channel in bearing face
18 Overhang/lip from bearing face
20 Bracket
21 Bracket ribs
22 Bracket opening for a fastener to a horizontally orientated frame
23 Bracket opening(s) for fasteners into a vertically orientated frame
24 Bracket edge abutting the lip or overhang of a washer
30 Plaster board/dry wall
X Incline angle relative to the horizontal plane axis
Y Incline angle relative to the vertical plane axis
x Horizontal axis
y Vertical axis

### Example 1

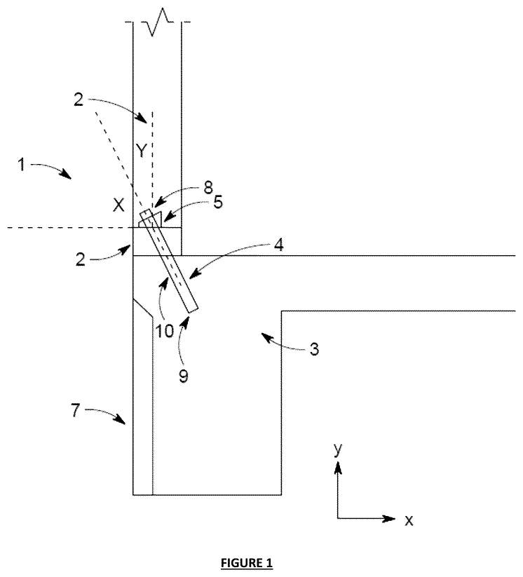

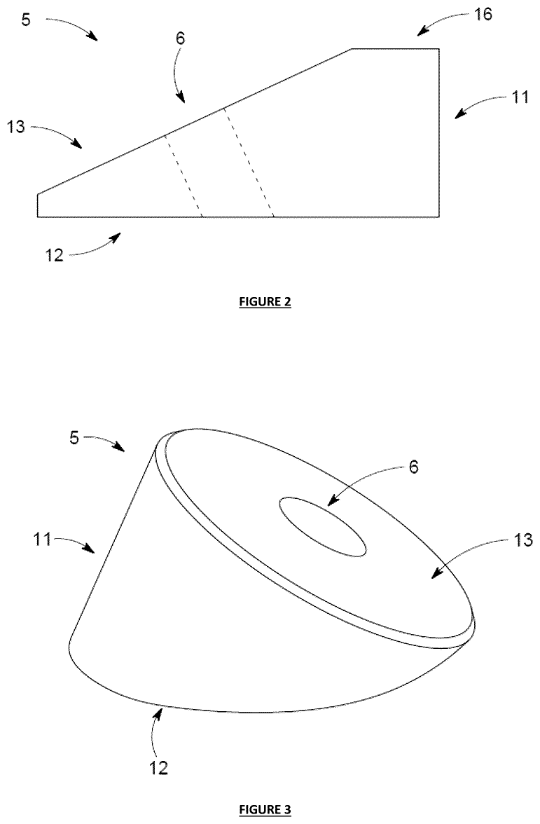

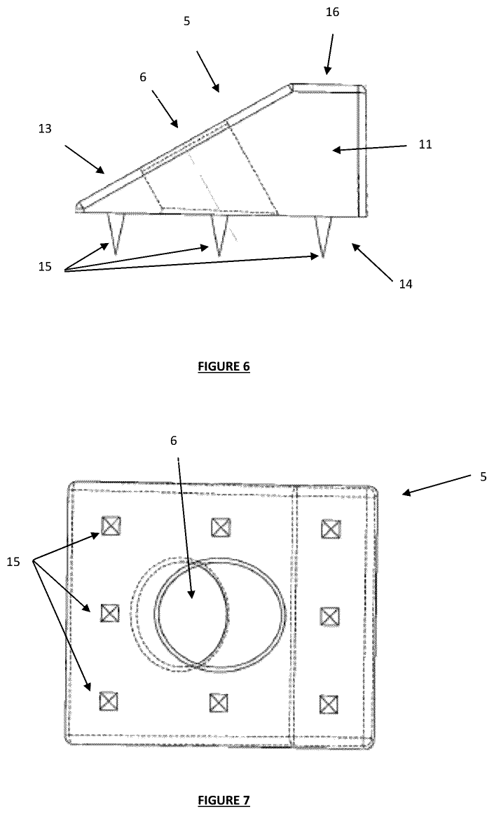

A coupling system 1 configured to couple a vertical structure 2 to a horizontal structure 3 is shown in FIGS. 1 to 7. The coupling system 1 comprises a fastener 4 and a washer 5. As shown, the washer 5 is configured to direct the fastener 4 on an angle through a bore 6 relative to a vertical plane (axis y) so as to direct and retain the fastener 4 once fitted on an incline angle Y relative to the vertical plane axis y of the vertical structure 2 and on an incline angle X relative to a horizontal plane axis x of the horizontal structure 3.

The vertical structure 2 as shown in FIG. 1 comprises wall framing with a vertical post and lower beam of the vertical framing.

The horizontal structure 3 as shown in FIG. 1 may be a concrete foundation. As shown, the concrete foundation may have an external insulating area 7 manufactured in this example from polystyrene. The angled fastener 4 avoids this weakened area and couples the vertical structure 2 to the horizontal structure 3 in a direction away from the insulating area 7.

The fastener 4 may be defined by a head 8, a point 9, a shaft 10 linking the head 8 and point 9. Members (not shown) may extend from and along part or all of the shaft 10 e.g. a thread. The point 9 extends through the vertical structure 2 and into the horizontal structure 3 on coupling. The fastener 4 head 8 acts as a stop to prevent excess movement of the fastener 4 shaft 10 into the vertical or horizontal structure 2, 3. The head 8 may remain flush with a top face of the washer 5 once coupled.

The washer 5 as noted may comprise a triangular cross-section shape generally indicated by arrow 11 as viewed from a side of the washer 5. The washer 5 may have a bearing face 12 or faces 12 that bear on a surface of a vertical structure 2 and an outer face 13 away from the vertical structure 2.

The triangular shape 11 may be a right angle triangle shape. This shape is likely to be used about a horizontal to vertical transition e.g. at a junction between a vertical structure 2 bottom beam and an upwardly extending post. The washer 5 triangular shape may be of other triangular shapes and mounted along various points of a vertical structure 2.

The bore 6 may be located on the triangular cross-section 11 about the thickest or widest point of the washer 5. The bore 6 may have an opening width that interferes with or is smaller than the fastener 4 width or which is equal to or slightly larger than the fastener 4 width.

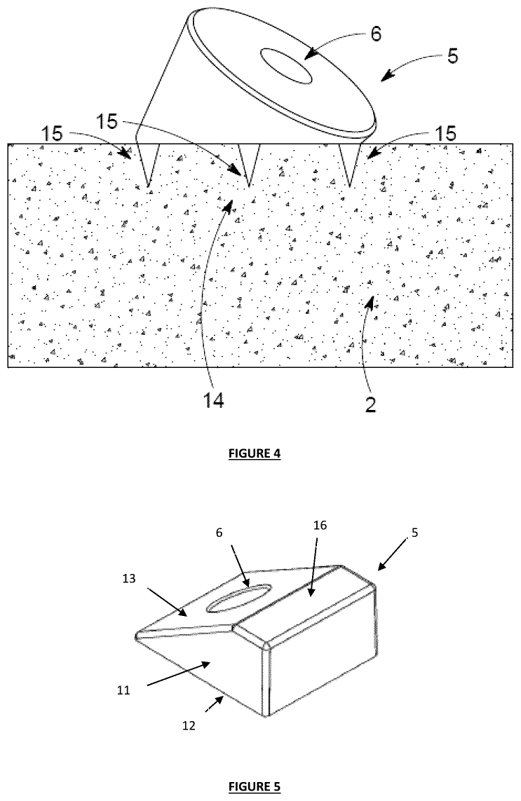

The washer 5 may further comprise at least one friction increasing face 14. The friction increasing face 14 may bear on the vertical structure 2 to which the washer 5 is placed or abuts. The friction increasing face 14 may comprise spikes 15 such as that shown in FIGS. 4, 6 and 7 that bear on and partially bite into the surface to which the washer 5 is applied e.g. partially bite into the wood of a vertical structure 2.

The outer face 13 of the washer 5 may also comprise a feature such as a non-angled flat face 16. The non-angled flat face 16 may be hit by a hammer or other tool to fit the washer 5 to a surface of the vertical structure 2 prior to coupling using the fastener 4.

Coupling of the coupling system 1 may be completed by selecting a coupling system 1 substantially as described above and driving the fastener 4 through the washer 5, vertical structure 2 and horizontal structure 3. Prior to driving the fastener 4, the washer 5 may be tapped into place on the vertical structure 2 and then the fastener 4 driven.

### Example 2

In this example, an alternative washer and coupling is described. In this example a bracket in the form of a Handibrac™ is used intermediate the washer and vertical structure that a fastener is passed through during assembly.

Handibrac™ brackets are widely used at least in New Zealand for fastening drywall panels to framing or for fastening framing together. These brackets, when located on a foundation edge, face a similar problem to other couplings where the fasteners ideally need to be angled in order to have them fasten to the concrete foundation and not drive into an insulating layer if fastened straight down.

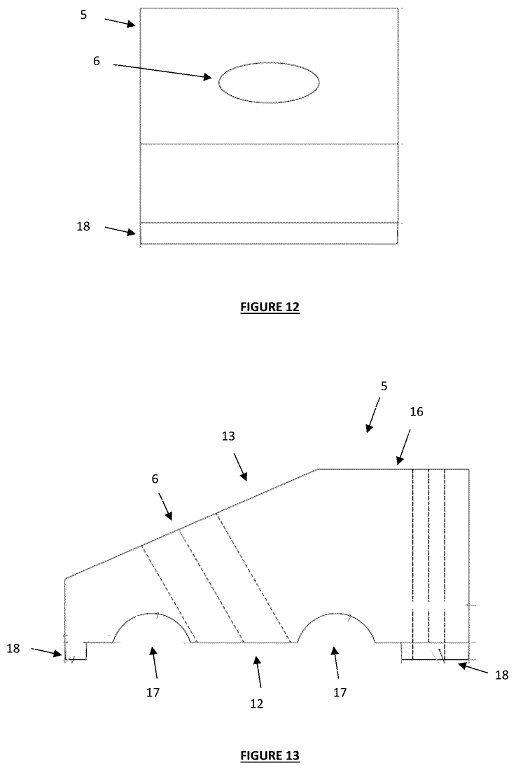

FIGS. 8 to 14 illustrate this alternate approach further.

FIG. 8 shows a perspective view from above of a bracket 20 widely used in construction. The bracket 20 comprises ribs 21, a bracket opening 22 for a fastener 4 to a horizontally orientated frame 2b, bracket openings 23 for fasteners (not shown) into a vertically orientated frame 2a and bracket edges 24.

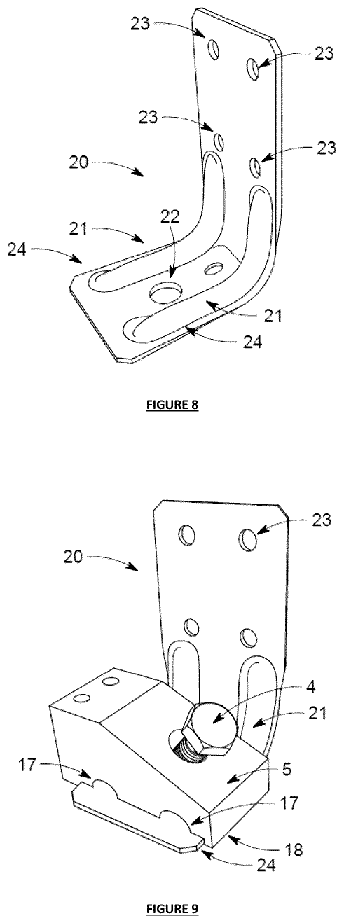

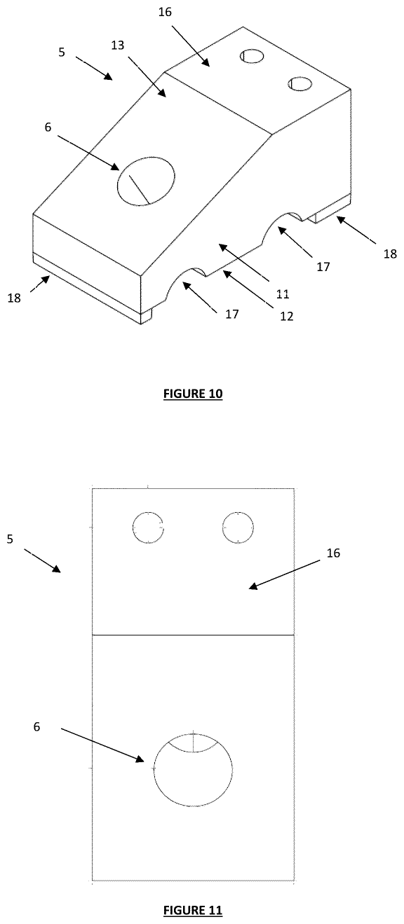

FIG. 9 shows a perspective view from above of an alternative washer 5 fitted to the bracket 20 of FIG. 8 with a fastener 4 loosely fitted into the washer 5 bore 6 ready for assembly. FIGS. 10 to 13 show more details of the alternative washer 5.

The washer 5 comprises the features described in Example 1 along with channels 17 in the bearing face 12 and overhang/lips 18 from ends of the bearing face 12. The channels 17 and lips 18 act as alignment features against the bracket 20 ribs 21 and bracket edges 24. The ribs 21 fit into the channels 17 and this prevents relative movement at least in a horizontal plane between the washer 5 and the bracket 20. The overhang or lips 18 shown in the Figures at either end of the washer 5 abut or interfere with rotational movement of the washer 5 relative to the bracket 20 also in a horizontal plane (or same plane as the bracket 20 face on which the bearing face 12 of the washer 5 abuts).

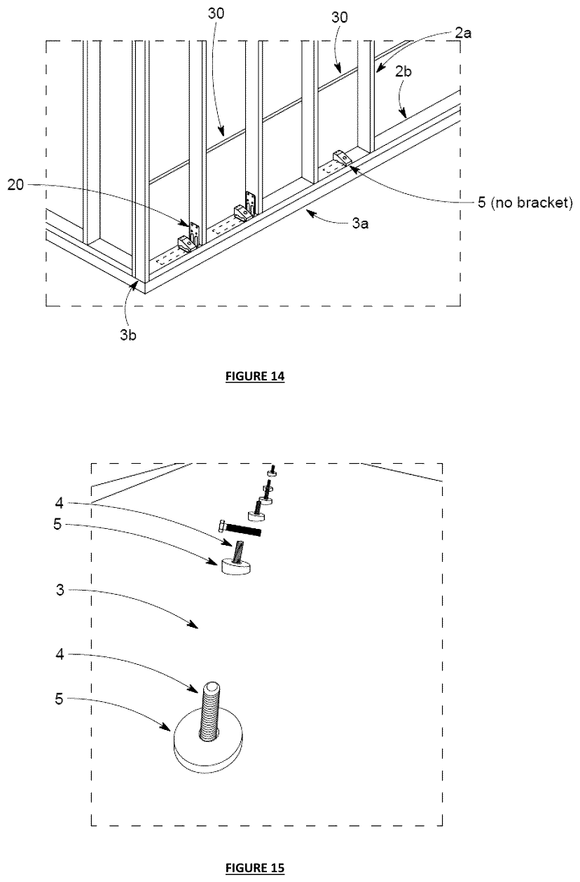

FIG. 14 shows a schematic of the washer 5 (with and without brackets 20) used to couple a vertical structure 2 to a horizontal structure 3. In this Figure, a corner of a building structure is shown comprising a vertical structure 2 made up of vertically orientated framing 2a and horizontally orientated framing 2b. Beneath the vertical structure 2 is the horizontal structure 3. This horizontal structure 3 comprises a concrete floor panel 3b and polystyrene insulation 3a that reaches the building foundation edge and which is non-structural. Drywall liner or plasterboard 30 is shown partially fixed to an internal side of the vertical structure 2. As shown, washers 5 and fasteners 4 used in the coupling 1 may be used alone or in combination with brackets 20 such as those described above with or without alignment features.

### Example 3

The washer shape shown in Example 1 and Example 2 may as noted take a variety of forms and geometry albeit that the washer comprises a bore of a pre-set angle configured to given the incline angle of a fastener placed through the washer.

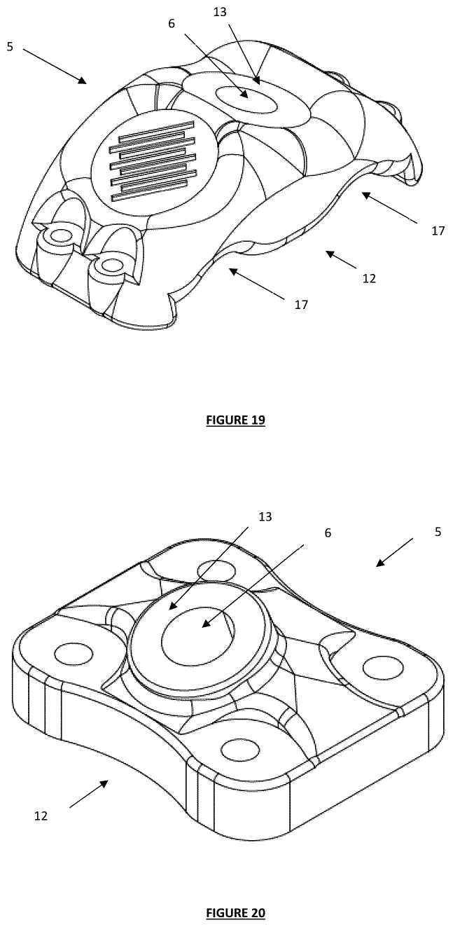

FIG. 19 and FIG. 20 illustrate two alternative shapes of washer 5.

In FIG. 19 the washer 5 shown uses a bore 6 with an outer face 13 bearing face 12. The bearing face 12 comprises a shape with channels 17 in the bearing face 12. In this case, the body of the washer 5 is more rounded to suit a desired aesthetic.

In FIG. 20, the washer 5 comprises a flat bearing face 12 configured to sit flat on a substrate (not shown). The washer 5 still comprises a bore 6 albeit the bore opening extends slightly about the main outer face 13 of the washer 5.

As demonstrated in this example, a number of other possible shapes of washer 5 may be used to interface with brackets or substrates and include openings for fixing fasteners and comprise other design features such as webbing.

### Example 4

In this example, the coupling system 1 described in Example 2 was subjected to pull out trials using varying incline angles.

The trial involved preparation of a number of threaded rod 4/washer 5 combinations at varying angles Y in a concrete foundation 3 (horizontal infrastructure). The trial combinations are shown in FIG. 15 which shows a photo of the threaded rods 4 and washers 5 prior to testing. The threaded rods 4 tested were either M12 or M16 diameter threaded shaft rods 4.

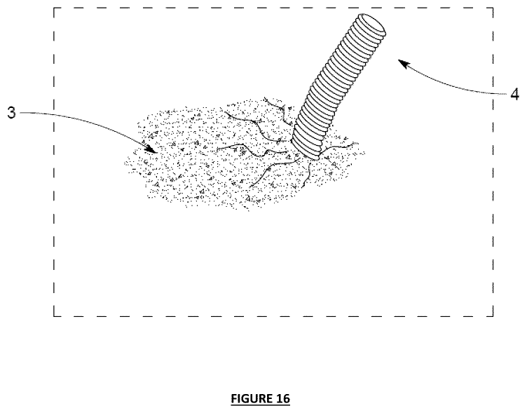

A test rig (not shown) was prepared designed to impose an upwards force on a vertical or y axis direction on the threaded rod 4. This force could be carefully controlled and increased to test against a measured deflection of the rod 4 shaft (and ultimately complete failure however this did not occur for any testing completed). An example image of a threaded rod 4 with the washer 5 removed post testing is shown in FIG. 16. As shown, the rod 4 has deflected slightly and this has had a minor effect on the top layer of concrete of the substrate 3. The rod 4 did not extract from the concrete substrate 3 in any trials completed.

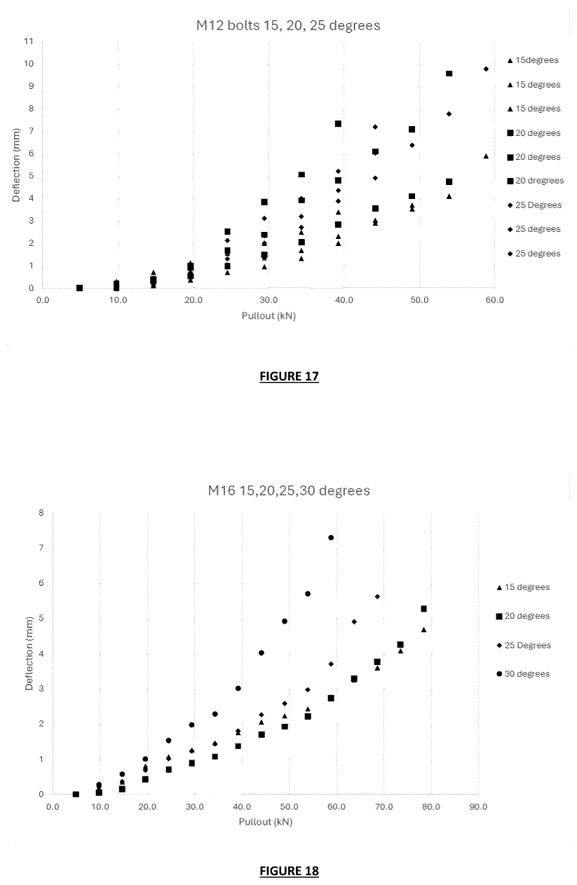

The results found for the M12 threaded rod 4 are illustrated in the graph shown in FIG. 17. The x axis shows the increasing pull out strength imposed by the test rig on the threaded rod 4 and washer 5. The y axis measures the amount of rod 4 deflection measured as the pull out force increased. The different relationship between deflection and pull out force was measured using rods 4 inserted at an angle of 15 degrees, 20 degrees and 25 degrees. In this example, each angle of incline Y was completed three times. As shown in FIG. 17, a curve of results was identified for each sample as the force and deflection increased. While none of the samples failed completely, samples with a sharper angle Y e.g. 15 degrees performed far better than those with a wider angle Y e.g. 25 degrees. For example, for a deflection of 5 mm, the measured pull out was approximately 1750 for 25 degrees, approximately 2000 for 20 degrees and approximately 2800 for 15 degrees i.e. a near 30% increase in strength via a reduction in angle Y from 25 to 15 degrees.

The results found for the M16 threaded rod 4 are illustrated in the graph shown in FIG. 18. Like in FIG. 17, the x axis shows the increasing pull out strength imposed by the test rig on the threaded rod 4 and washer 5 and the y axis measures the amount of rod 4 deflection measured as the pull out force increased. The different relationship between deflection and pull out force was measured in this trial using rods 4 inserted at an angle Y of 15 degrees, 20 degrees, 25 degrees and 30 degrees. Again, none of the samples failed completely however, samples with a sharper angle Y e.g. 15 or 20 degrees performed better than those with a wider angle Y e.g. 25 or 30 degrees. For example, for a deflection of 5 mm, the measured pull out was approximately 2500 for 30 degrees, approximately 3300 for 25 degrees, approximately 3900 for 20 degrees and approximately 4200 for 15 degrees i.e. a near 40% increase in strength via a reduction in angle from 30 to 15 degrees.

The results for the M12 and M16 rods 4 tested indicate that a steeper angle Y may provide greater strength and this may be 15-20 degrees although anything up to 30 degrees still did not fail the tests completed by the inventor. This steeper angle also may be useful to reduce the extent of deflection of a rod 4 on experiencing a lift out force. The less steep the angle of incline Y, the greater the amount of deflection was measured for a given lift out force.

In a subsequent trial completed on behalf of the inventor where the angled rods 4 and washers 5 were used to secure a building portal (not shown), the steeper angle Y rods 4 (15-20 degrees) achieved a higher bracing unit (BU) score than a shallower angle Y e.g. 30 degrees. Bracing scores of up to 158 bracing units or BU were achieved.

This angle of inclination Y may be at least partly related to the stiffness of the material used to form the rod 4. A high stiffness rod 4 may allow for a greater angle of inclination Y than a more ductile material rod 4 which may be more inclined to bend and fail.

Aspects of the coupling system, washer and method of coupling have been described by way of example only and it should be appreciated that modifications and additions may be made thereto without departing from the scope of the claims herein.

What is claimed is:

1. A coupling system configured to couple a vertical structure to a horizontal structure comprising:
a fastener;
a washer;
wherein the vertical structure is selected from wall framing or wall panels, poles, posts, beams, portal frames and combinations thereof; and
wherein the horizontal structure is selected from concrete or timber foundations, piles and combinations thereof;
wherein the washer is configured to direct the fastener on an angle relative to a vertical plane so as to direct, and retain the fastener once fitted, on an incline angle relative to the vertical plane of the vertical structure and, on an incline angle relative to a horizontal plane of the horizontal structure.

2. The coupling system as claimed in claim 1 wherein the incline angle of an installed fastener through the washer is from 10 to 30 degrees relative to a vertical plane.

3. The coupling system as claimed in claim 1 wherein the fastener comprises a head, a point, a shaft linking the head and point and members extending from and along part or all of the shaft.

4. The coupling system as claimed in claim 3 wherein the point extends through the vertical structure and into the horizontal structure on coupling.

5. The coupling system as claimed in claim 3 wherein the head of the fastener remains flush with a top face of the washer.

6. The coupling system as claimed in claim 1 wherein the fastener has a length sufficient to extend through the vertical structure and at least 20 mm into the horizontal structure.

7. The coupling system as claimed in claim 1 wherein the fastener has a diameter from 5 to 20 mm.

8. The coupling system as claimed in claim 1 wherein the washer comprises a substantially triangular cross-section as viewed from a side.

9. The coupling system as claimed in claim 1 wherein the washer has a bearing face or faces that bear on a surface of a vertical structure and an opposing outer face.

10. The coupling system as claimed in claim 9 wherein the washer comprises at least one alignment feature configured to align the washer to a bracket or other part intermediate the bearing face and the vertical structure of the washer.

11. The coupling system as claimed in claim 1 wherein the washer has a bore and this bore receives the fastener therethrough.

12. The coupling system as claimed in claim 8 wherein the washer has a bore and this bore receives the fastener therethrough and wherein the bore is located on the substantially triangular cross-section about a generally thicker or wider point of the washer.

13. The coupling system as claimed in claim 11 wherein the bore has an opening width that interferes with a width of the fastener or, is smaller than a width of the fastener, or is equal to a width of the fastener, or is slightly larger than a width of the fastener.

14. The coupling system as claimed in claim 1 wherein the washer further comprises at least one friction increasing face that bears on the vertical structure to which the washer abuts.

15. The coupling system as claimed in claim 10 wherein the at least one alignment feature comprises channels in the bearing face of the washer that complement opposing features of the bracket or other part intermediate the bearing face of the washer and the vertical structure.

16. The coupling system as claimed in claim 10 wherein the at least one alignment feature comprises a lip or lips about sides or ends of the bearing face of the washer that extend partly below the bearing face and which engage a side or sides or end of a bracket or other part intermediate the bearing face of the washer and the vertical structure.

17. The coupling system as claimed in claim 1 wherein an outer face of the washer comprises a feature configured to be hit by a hammer or other tool.

18. A washer configured to direct and retain a fastener in an angled orientation during coupling of a vertical structure to a horizontal structure, the washer comprising:
a substantially triangular cross-section shape with at least one bearing face that bears on the horizontal structure or the vertical structure and an opposing outer face;
a bore extending from the opposing outer face to the at least one bearing face, the bore configured to accept and direct the fastener therethrough;
wherein the vertical structure is selected from wall framing or wall panels, poles, posts, beams, portal frames and combinations thereof; and
wherein the horizontal structure is selected from concrete or timber foundations, piles and combinations thereof;
wherein the bore is configured during coupling of a vertical structure to a horizontal structure, to direct the fastener on an incline angle relative to a vertical plane of the vertical structure and, on an incline angle relative to a horizontal plane of the horizontal structure.

19. The washer as claimed in claim 18 wherein the at least one bearing face comprises a shape confirming to the shape of a bracket on which the washer is placed.

20. A method of coupling a vertical structure to a horizontal structure by:
selecting a coupling system as claimed in any one of claims 1; and
driving the fastener through the washer, the vertical structure and the horizontal structure.
